(19) United States
(12) Patent Application Publication
(10) Pub. No.: US 2024/0248261 A1
(43) Pub. Date: Jul. 25, 2024

(54) HIGH-DENSITY TWO-DIMENSIONAL OPTICAL FIBER ARRAY

(71) Applicant: Fuzhou Photop Optics Co., Ltd.

(72) Inventors: Xu Jia, Fuzhou (CN); Junjie Chen, Fuzhou (CN); Hengyi Fu, Fuzhou (CN); Yan Jiang, Fuzhou (CN); Guanglong Yu, Fuzhou (CN); Lei Lin, Fuzhou (CN)

(21) Appl. No.: 18/111,028

(22) Filed: Feb. 17, 2023

(30) Foreign Application Priority Data
Jan. 19, 2023 (CN) 2023100743427

(51) Int. Cl. G02B 6/36

(52) U.S. Cl. CPC G02B 6/3672

(57) ABSTRACT

An optical fiber array device, where the optical fiber array device comprises a fiber base flange, enabled to hold an integrated positioning sheet. The integrated positioning sheet comprises a plurality of channels, with each formed by at least a positioning hole and a tapered hole. A plurality of fibers or fiber bundles are fixed in the positioning holes of the integrated positioning sheet. The device further comprises a lens array, with each lens of the lens array aligned with one channel of the plurality of channels.

### CROSS-REFERENCE TO RELATED APPLICATION

This patent application claims priority to and the benefit from Chinese Patent Application CN 2023100743427 filed Jan. 19, 2023 at the Chinese National Intellectual Property Administration (CNIPA). The above application is incorporated by reference herein.

### TECHNICAL FIELD

The present disclosure generally relates to high performance and high reliability optical fiber arrays and methods for forming optical fiber arrays.

### BACKGROUND

Aspects of the present disclosure relate to a high-density two-dimensional optical fiber array. Various issues may exist with conventional solutions for optical fiber arrays. In this regard, conventional systems and methods for optical fiber arrays may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims are optical fiber arrays and methods for forming optical fiber arrays.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 an explosion drawing of a two-dimensional high-density fiber array assembly.

FIG. 2 shows an exemplary cross-section of a channel formed by holes on a multi-layer positioning sheet stack.

FIG. 3 shows an exemplary cross-section of a channel formed by holes on a multi-layer positioning sheet stack.

FIG. 4 shows an exemplary integrated positioning sheet.

FIG. 5 shows an exemplary multilayer positioning sheet stack.

FIG. 6 shows an explosion drawing of a two-dimensional high-density fiber array assembly with a spacer and a lens array.

FIG. 7 shows an explosion drawing of a two-dimensional high-density fiber array assembly with an air space and a lens array mounted on a positioning substrate.

FIG. 8 shows an explosion drawing of an exemplary two-dimensional high-density fiber array assembly with a lens array, combined with an integrated positioning sheet.

FIG. 9 depicts a two-dimensional high-density fiber collimator lens assembly.

### DESCRIPTION

The following discussion provides various examples of optical fiber arrays and methods for forming optical fiber arrays. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

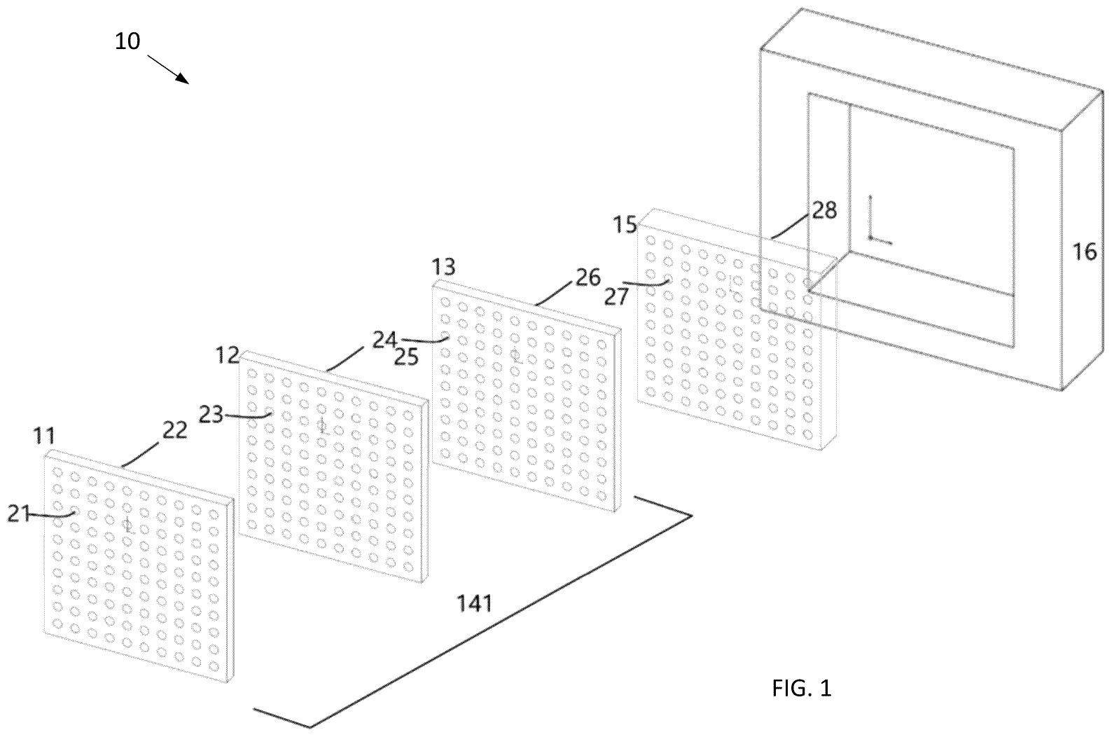

Referring now to FIG. 1, there is shown an explosion drawing of a two-dimensional high-density fiber array assembly 10. A two-dimensional high-density fiber array assembly 10 may be operable to receive fibers or fiber bundles through fiber base flange 16, such that the fibers or fiber bundles may be precisely located in the positioning sheet 11, in positioning holes 21, as will be illustrated and explained with reference to the figures.

There is shown a fiber base flange 16, a guide hole array block 15, and a multilayer positioning sheet stack 141. The multilayer positioning sheet stack 141 may comprise a positioning sheet 11, a supporting sheet 12 and a guiding sheet 13. The positioning sheet 11 comprises positioning holes 21 and tapered holes 22. The supporting sheet 12 comprises holes 23 and tapered holes 24. The guiding sheet 13 comprises holes 25 and tapered holes 26. The guide hole array block 15 comprises holes 27 and tapered holes 28.

The fiber base flange 16 may be enabled for attaching, stabilizing and guiding the positioning sheet stack 141 and the guide hole array block 15 in its cavity. The fiber base flange 16 may ensure the alignment of the multilayer positioning sheet stack 141 and the guide hole array block 15. The fiber base flange 16 may be processed from a material with low thermal expansion coefficient.

The guide hole array block 15 may comprise high-density holes (holes 27 and tapered holes 28) with a one-to-one correspondence to holes on the positioning sheet stack 141. There may be, for example, N rows and M columns of holes 27, 28 illustrated. In accordance with various embodiments of the invention, the holes in sheets 11, 12, 13, 15, and/or 141, 142, 143 (see also later figures) may be arranged in a rectangular distribution, circular distribution, or any other shape distribution. The various holes 21, 22, 23, 24, 25, 26, 27, 28 may be aligned as will also be illustrated with reference to further figures. The guide hole array block 15 may be enabled to receive fibers or fiber bundles. The fibers or fiber bundles may be fixed in the guide hole array block 15 by high reliability glue and/or sealant. The size of the holes 27, 28 of the guide hole array block 15 may be larger than the size of the holes of the positioning sheet stack 141, to enable the guiding of fiber from behind fiber base flange 16 through the guide hole array block 15 to the positioning sheet stack 141. The tapered holes 28 of the array block 15 may be tapered with a chamfer on the fiber entry side. The function of the array block 15 is to guide an optical fiber into a correct channel of the multilayer positioning sheet stack 141. This guiding functionality of array block 15 may reduce the difficulty of assembly. The one-to-one correspondence of holes between the guide hole array block 15 and the multilayer positioning sheet stack 141 may form a structure to receive fibers from larger holes to smaller diameter holes. When assembling the optical fiber assembly 10, the optical fiber may have a larger positioning margin, which may reduce the difficulty of assembly and may help to ensure the accuracy of the final position of the optical fiber. Array block 15 and the multilayer positioning sheet stack 141 may be held in position in the fiber base flange 16 by glue, for example.

The multilayer positioning sheet stack 141 may comprise one or more sheets. The multilayer positioning sheet stack 141 is operable to position an optical fiber array passing through it precisely. Thus, the multilayer positioning sheet stack 141 may be operable to guide fibers or fiber bundles through its positioning holes 21. Fiber may be passed to the multilayer positioning sheet stack 141 through the fiber base flange 16 and the guide hole array block 15. The surface of the multilayer positioning sheet stack 141 may be sanded and polished. The holes in the multilayer positioning sheet stack 141 may be through holes. The holes in the multilayer positioning sheet stack 141 may be formed by aligning the holes 21, 22, 23, 24, 25, and 26.

The positioning sheet 11, supporting sheet 12, and guiding sheet 13 forming the multilayer positioning sheet stack 141 may be made from monocrystalline silicon sheets, for example.

Generally, the multilayer positioning sheet stack 141 may comprise one or more supporting sheets 12. The holes 23 and the tapered holes 24 of the supporting sheet 12 may be aligned with the holes of the positioning sheet 11 and the holes of the guiding sheet 13. The holes of the supporting sheet 12 may be enabled to support the optical fiber. The positioning sheet 11 and the supporting sheet 12 may be aligned tightly together. In some instances, as will be shown with reference to other figures, the positioning sheet 11 and the supporting sheet 12 may be machined in one combined sheet.

The supporting sheet 12 may be operable to guide the optical fiber into a correct position on the positioning sheet 11 when the optical fiber array is assembled. In some instances, the holes 23 (and/or holes 24) on the supporting sheet 12 may be of a larger diameter than the holes on the positioning sheet 11. This may assist an assembly process in that the fiber may be less likely to bend and deflect when passing through the fiber channel, formed by the holes of the various sheets (e.g., 11, 12, 13, 15, 141, 142, 143). The support sheet 12 with a slightly larger aperture can also prevent glue from escaping the fiber channel that is formed by the holes. Specifically, the glue may be prevented from flowing with the fiber due to the capillary effect and remains in the fiber channel of the support sheet. When more than one supporting sheet 12 are used, the supporting effect and the prevention of unwanted flow of glue may be improved. In accordance with various embodiments of the invention, the thickness of support sheet 12 may vary. For example, the supporting sheet 12 may be manufactured from a silicon-based material or also from glass. As will be known to the person skilled in the art, other materials may be used for the supporting sheet 12. In some instances, when thinner materials are used, more supporting sheets 12 may be desirable, i.e., multiple layers of supporting sheets 12.

The positioning sheet 11 may comprise multiple high density, high precision through holes, as illustrated by exemplary positioning holes 21 and tapered holes 22. The positioning holes 21 and or tapered holes 22 may be, for example, etched. Positioning sheet 11 may be operable to precisely position an optical fiber array passing through it, specifically passing through its holes 21, 22. The holes 22 through the positioning sheet 11 may be tapered. In some instances, the tapered holes 22 may not be tapered, so that the through hole generated from positioning holes 21 and holes 22 may be straight. The diameter of the positioning holes 21 may be matching the diameter of the optical fibers or fiber bundles used. The positioning sheet 11 may be bonded to the supporting sheet 12, which may in turn be bonded to the guiding sheet 13, to form the multilayer positioning sheet stack 141. The bonding may be obtained, for example, glue-free, by anodic bonding, diffusion bonding, epoxy-free bonding, bonding after film plating or metal film, side gluing, and encapsulation, but may not be so limited.

Alignment marks may be etched on each flat sheet (e.g. 11, 12, 13) through a high precision mask to ensure that the centers of all holes 21-26 are on the same centerline after bonding. Because the positioning sheet 11 may be highly precise, it may be desirable to use a multilayer positioning sheet stack 141 such that supporting sheet 12 and the guiding sheet 13 may be manufactured to a slightly less precise standard than the positioning sheet 11, which may be simpler and cheaper. In some instances, the positioning sheet 11 and the supporting sheet 12 may be processed as a single flat sheet. A single flat sheet combining positioning sheet 11 and supporting sheet 12, may be advantageous because it avoids laminating the positioning sheet 11 and the supporting sheet 12, which may reduce cost. The lamination of positioning sheet 11 and the supporting sheet 12 may also lead to alignment issues of the corresponding holes. Through holes may be obtained by etching or using CNC or laser drilling. Often, the through holes in the positioning sheet 11 are desired to be tapered on the optical fiber entry side, for example, using tapered holes 22. The tapering on the optical fiber entry side may generally facilitate the assembly. The material of the positioning sheet 11 may be glass, silicon, ceramic or and other solid material that may be processed. In some instances, after the fiber assembly is complete, the positioning sheet 11 may be ground and/or polished. The grinding process may be used to quickly remove protruding optical fiber ends and remove defects on the surface. In the polishing process after grinding, the surface of the positioning sheet 11 can be made highly precise. In some instances, after grinding and polishing, the optical fiber array may be subjected to a stress-relieving temperature cycle for a certain period of time. This may enable residual stress of the optical fiber fixed in the optical fiber protective cover to be released. Also, in subsequent use, the optical fiber may be better fixed even in changing ambient temperatures.

The position of the through holes illustrated in FIG. 1 to FIG. 9 may be arranged in any desirable pattern on e.g. the positioning sheet stack 141 and the guide hole array block 15, including but not limited to, a rectangular pattern, a circular pattern, or any other desirable pattern. In some instances, the spacing between the through holes may be small, in other instances the spacing may be large. In accordance with various embodiments of the invention, the positional accuracy of the through holes may be less than 1 μm, in some cases the positional accuracy may be less than 500 nm.

To load the two-dimensional high-density fiber array assembly 10 with fiber, a row of fibers is stripped of a certain length of protective/coating layer and positioned in a fixture. The fiber is then passed through the rear port of the fiber optic base flange 16, so that the fiber passes through guide holes on the guide hole array block 15, the guiding sheet 13, the supporting sheet 12, and the positioning sheet 11. The fiber ends thus emerge after assembly from the front side of the positioning sheet 11. This may be repeated for several rows. The loading may not be limited to loading by row, as will be understood by the person skilled in the art.

High-density two-dimensional fiber arrays may be a core optical device used in high-density matrix optical switches and high-channel wavelength selective switches (WSS). In order to meet the needs of intelligent optical network management and high-speed optical switching, high-density matrix optical switches and high-channel WSS may be deployed in optical networks on a large scale. An M×N two-dimensional fiber array may be collimated by an M×N collimator array to form a set of M×N collimated beams at the back focal plane in space, as will be illustrated with reference to the figures.

The positioning sheet 11, supporting sheet 12, guiding sheet 13 and guide hole array block 15 may also be attached together without glue. This may, in some instances, prevent blockage of holes in the flat sheets, which would prevent fiber passing through the channel formed by the holes.

The glue-free structure may prevent blockage of high-density, high-precision through holes on the flat sheets. Correspondingly, the superposition and lamination of two or more flat sheets may be completed in a glue-free manner. The bonding method includes, but is not limited to, anodic bonding, diffusion bonding, epoxy-free bonding, bonding after film plating or metal film, etc., side gluing and encapsulation, etc.

In some instances, a thin optical fiber array assembly 10 may be desirable, for example less than 1 mm, or less than 0.8 mm. In those cases, a single positioning flat sheet 11 may be used to form the high-density two-dimensional optical fiber array.

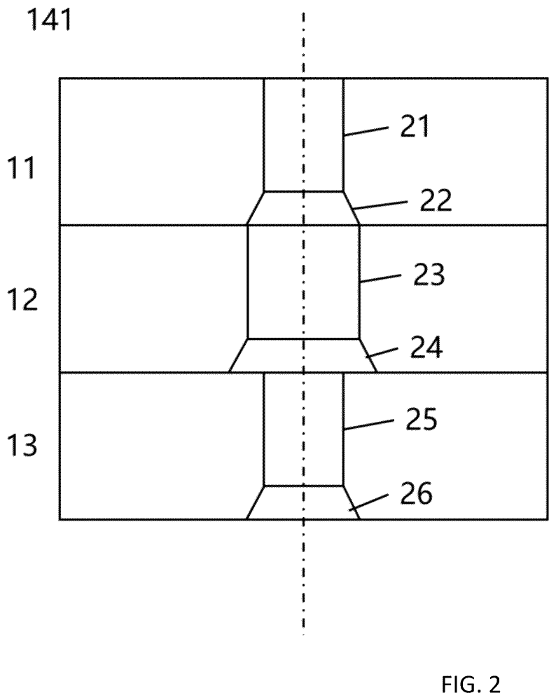

FIG. 2 shows an exemplary cross-section of a channel formed by holes on a multi-layer positioning sheet stack 141. As Illustrated in FIG. 1, the multilayer positioning sheet stack 141 is formed from stacked sheets, for instance the lamination of positioning sheet 11, supporting sheet 12, and guiding sheet 13. A through hole channel is formed from aligned holes 21-26.

In assembly, the fiber may enter through tapered hole 26 to be fixed in a position slightly protruding from hole 21.

Hole 21 may be slightly larger than for example a bare fiber. Its diameter may be, for example, 1 μm larger than the diameter of the corresponding fiber. The positioning holes 21 may be placed with high precision on the positioning sheet 11, for example, using etching. The diameter of hole 23 in the supporting sheet 12, may be, for example, 30 μm larger than that of the positioning hole 21. Hole 23 may be enabled to maintain the level of the optical fiber in the stacking hole of the positioning sheet 11; to assist positioning for the fiber not to bend and cause stress; and to ensure the pointing angle of the optical fiber. Hole 23 may also prevent glue from flowing out of the multilayer positioning sheet stack 141 due to the capillary effect. In accordance with various embodiments of the disclosure, the tapered hole 24 may be of a diameter approximately 3 times the diameter of hole 23. The hole 25 may be of the same diameter as hole 21. The tapered hole 26 may be, for example, 3 times the diameter of hole 25. The larger diameter of hole 25 may facilitate assembly, and specifically entering the fiber through tapered hole 26 into the channel formed by the holes. This may also permit larger tolerances for the holes of guide sheet 13, which makes the assembly process easier and cheaper to operate. The person skilled in the art understands that the dimension of the holes, relative to each other and absolute, shall not be construed as limiting.

In some instances, the tapered hole 24 may be dispensed with. In those instances, the hole 23 is a through hole in supporting sheet 12. Because the diameter of hole 23 may be larger than the diameter of holes 21, 23, the tapered hole 24 may not be required.

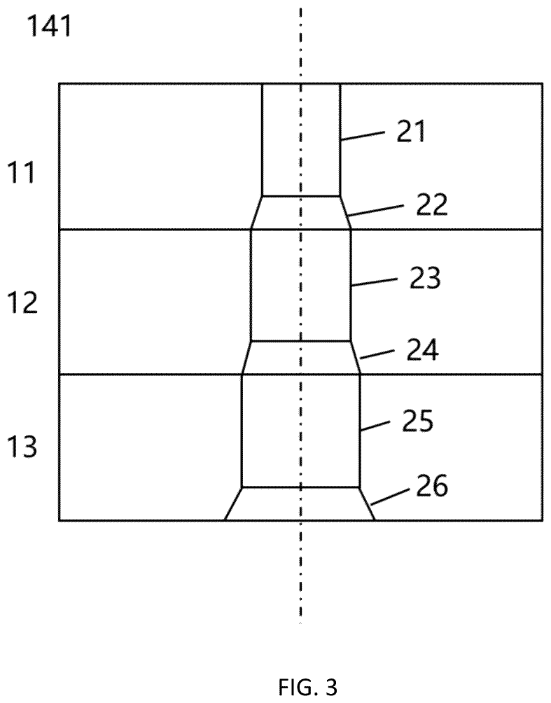

FIG. 3 shows an exemplary cross-section of a channel formed by holes on a multi-layer positioning sheet stack 141. As Illustrated in FIG. 1 and FIG. 2, the multilayer positioning sheet stack 141 is formed from stacked sheets, for instance the lamination of positioning sheet 11, supporting sheet 12, and guiding sheet 13. A through hole channel is formed from aligned holes 21-26.

In assembly, the fiber may enter through tapered hole 26 to be fixed in a position slightly protruding from hole 21.

FIG. 3 may be similar to FIG. 2. In FIG. 3, however, the diameters of hole 26 through hole 21 that form the channel through the multilayer positioning sheet 141 may be monotonically decreasing. That is, the tapered hole 26 may have the largest diameter of the holes, while the hole 21 may have the smallest diameter of the holes forming the channel. Similar to FIG. 2, hole 21 may be slightly larger than for example a bare fiber, or a fiber bundle. This arrangement may be desirable because the holes in the supporting sheet 12 and the guiding sheet 13 may be etched to a lesser precision than those for positioning sheet 11.

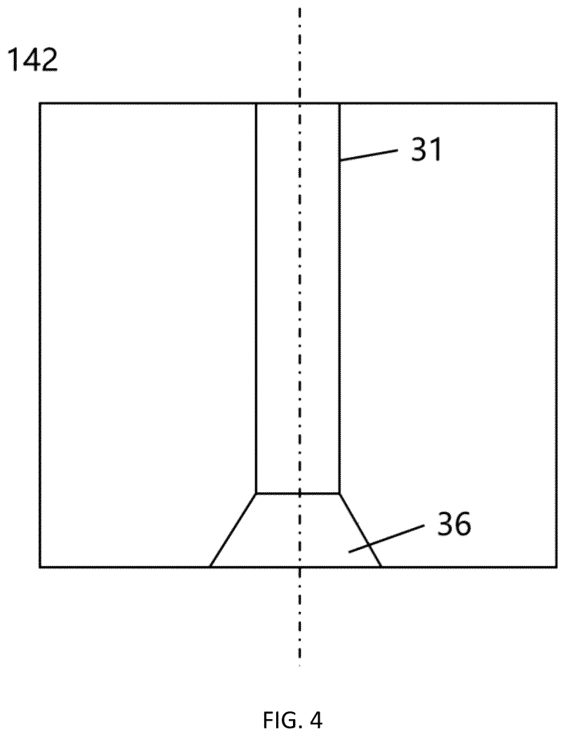

FIG. 4 shows an integrated positioning sheet 142. In some instances, it may be desirable to replace a multilayer positioning sheet stack 141 with a single layer integrated positioning sheet 142. The positioning flat sheet 142 may be etched from a single sheet of glass or silicon, for example. The positioning flat sheet 142 may comprise a hole 31, and a tapered hole 36. In effect, the integrated positioning sheet 142 may comprise a single layer made of a thicker positioning sheet 11. In accordance with various embodiments of the disclosure, the integrated positioning sheet 142 may be 2 mm thick and the length of the positioning hole 31 may be 1.6 mm, and the length of the tapered hole 36 may be 0.4 mm, for example. As will be known to the person skilled in the art, the dimensions of hole 31 and tapered hole 36 shall not be construed as limiting.

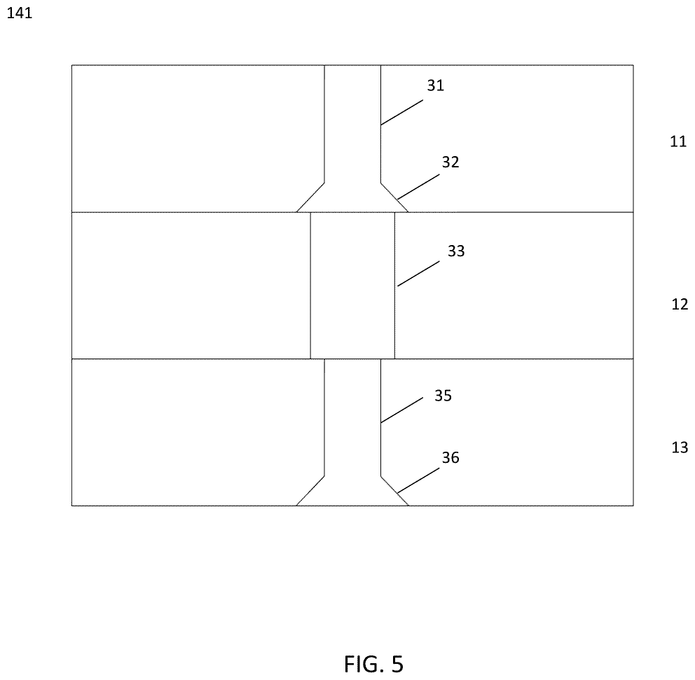

FIG. 5 depicts a multilayer positioning sheet stack 141. FIG. 5 may be similar to FIG. 3. The main difference may be that guide hole 33 in the supporting sheet 12 may be a straight through hole, without a taper. There is shown guide holes 35, 33, and positioning hole 31. There is also shown tapered holes 32, and 36. In accordance with various embodiments of the disclosure, the guide hole 35 may be of a substantially same diameter as the positioning hole 31, and the tapered hole 32 may be similar to the tapered hole 36. The straight through hole 33 may be of a larger diameter than positioning hole 31 and/or guide hole 35. Because of the larger diameter, hole 23 may also prevent glue from flowing out of the multilayer positioning sheet stack 141 due to the capillary effect. The holes 31, 32, 33, 35, 36 may be round or polygonal in shape, for example quadratic, rectangular, hexagonal or any other shape. The shape of the holes in FIG. 1 to FIG. 9 may more generally be any shape, including round or polygonal in shape, for example quadratic, rectangular, hexagonal or any other shape.

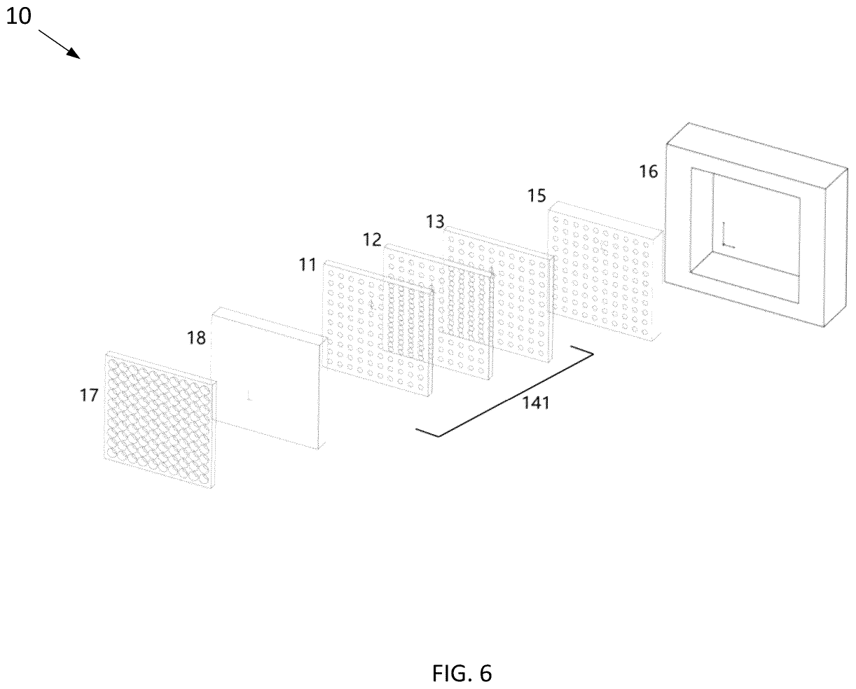

FIG. 6 depicts a two-dimensional high-density fiber collimator array assembly 10. FIG. 6 is similar to FIG. 1 but additionally comprises a lens array 17 and spacer 18. As may be seen from the explosion drawing in FIG. 6, the lens array 17 and the spacer 18 may be positioned in front of the positioning sheet 11. The lens array 17 may be made of glass or silicon and may comprise one or more lenses aligned with each fiber, or fiber bundle, placed in positioning holes 21 of the positioning sheet 11. Thus, the lenses of lens array 17 may be precisely aligned with the positioning holes 21 of the multilayer positioning sheet stack 141. The lenses of lens array 17 may be collimator lenses, for example.

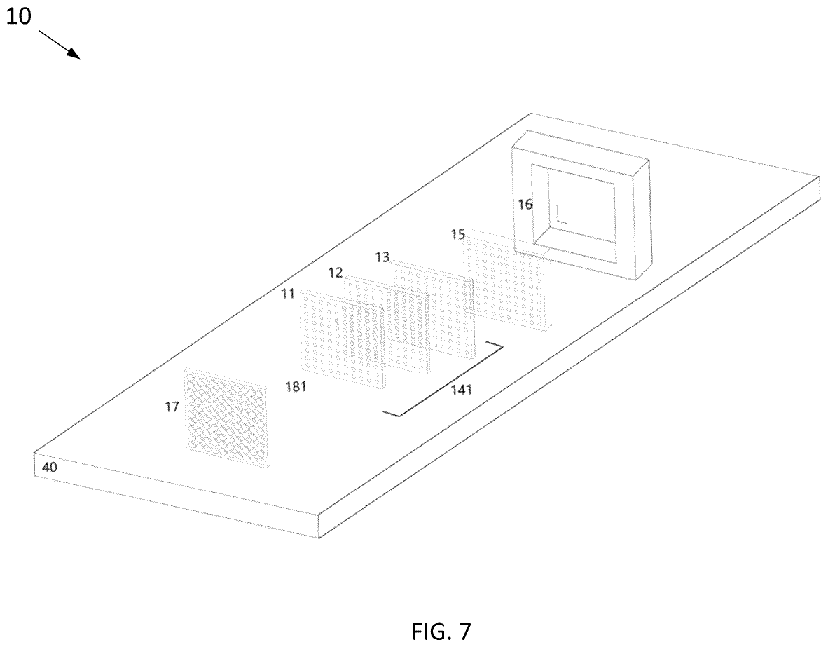

The spacer 18 may be made of glass, silicon or air (refer to air space 181 in FIG. 7). In some instances, the spacer may be made hollow. For example, the spacer 18 may be made of the same material as the lens array 17. Spacer 18 may have a thickness in the range of 0 to 20 mm. In accordance with various embodiments of the disclosure, the spacer 18 may be 3 mm thick. Spacer 18 may be operable to separate positioning sheet 11 from the lens array 17 at a desirable separation distance. Spacer 18, lens array 17, and the positioning sheet 11 of multilayer positioning sheet stack 141 may be bonded together by glue, for example. To obtain a small insertion loss (IL) and a large return loss (RL), when the refractive index of glue differs greatly from the refractive index of the fiber array and the lens array 17, the surface of the two-dimensional fiber array, and the surface of the lens array 17 and the fiber array which are bonded together may be optionally coated with an anti-reflection film for the glue; in addition, the exit surface of the lens array 17 may be coated with an anti-reflection film for the air. In some instances, to obtain a small insertion loss (IL) and a large return loss (RL), the surface of the two-dimensional fiber array and the surface of the lens array 17 may both be coated with an anti-reflection coating for air.

In an exemplary assembly process, the multi-layer positioning sheet stack 141 and the guide hole array block 15 may be fixed in the optical fiber base flange 16, and a high-precision optical fiber loading fixture with a V-shaped optical fiber fixing groove may be used (not shown in the figure). For fiber loading, a row of 1×N fiber optic ribbons may be stripped to a certain length of protective layer and coating layer, and then fixed on the fiber optic fixture with bare fibers. Then, the pre-arranged 1×N optical fiber ribbons may be passed through the rear port of the fiber base flange 16, and make the row of bare optical fiber ribbons pass through the guide holes on the guide hole array block 15 and the positioning on the multi-layer positioning flat plate stack 141 in turn, eventually passing through the front side (positioning sheet 11) of the multi-layer positioning sheet stack 141. After the optical fibers are fixed in the multi-layer positioning sheet stack 141 with e.g., glue, the optical fibers passing through the front surface of the multi-layer positioning sheet stack 141 may be removed by grinding and polishing. The spacer 18 may be attached to the front surface of the multi-layer positioning flat sheet stack 141 through the positioning tool and glue, and then the lens array 17 may be attached to the other side of the spacer 18 through a positioning tool and glue.

FIG. 7 depicts a two-dimensional high-density fiber collimator lens assembly 10. FIG. 7 may be similar to FIG. 6. However, FIG. 7 comprises a positioning substrate 40. The positioning substrate 40 may be made from metal, glass, or other solid materials. Note, that the embodiment of FIG. 7 does not require a spacer 18. Instead, FIG. 7 shows an air space 181. In the embodiment of FIG. 7, the multilayer positioning sheet stack 141 and the guide hole array block 15 may be fixed in the fiber base flange 16. This assembly in the fiber base flange 16 may be fixed to the positioning substrate 40. The lens array 17 may also be fixed to the positioning substrate 40 at an air space 181 separated from positioning sheet 11. The air space 181 may be, for example, 50 mm thick. As for FIG. 6, the lenses of lens array 17 may be aligned with the positioning holes 21 of the positioning sheet 11.

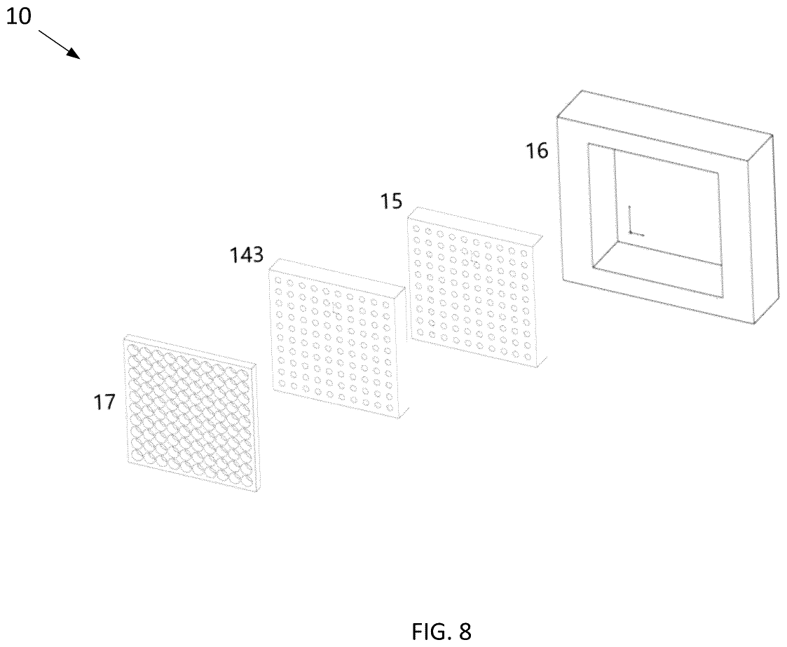

FIG. 8 depicts a two-dimensional high-density fiber collimator lens assembly 10. FIG. 8 may be similar to FIG. 7, but the multilayer positioning sheet stack 141 may be replaced by an integrated positioning sheet 143, as illustrated for example in FIG. 4 and FIG. 5 (by integrated positioning sheets 142, substantially similar to the integrated positioning sheet 143). The integrated positioning sheet 143 may be made of glass, for example, which may be the same material as used for lens array 17. The lenses of lens array 17 may be aligned with the positioning holes of the integrated positioning sheet 143.

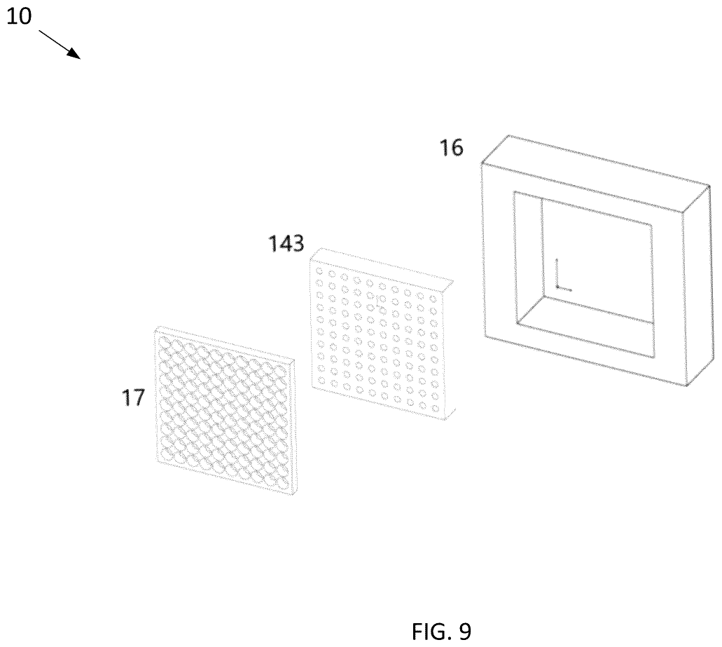

FIG. 9 depicts a two-dimensional high-density fiber collimator lens assembly 10. FIG. 9 may be similar to FIG. 8, but may not require the guide hole array block 15. As shown in FIG. 9, an integrated positioning sheet 143 and a lens array 17 may be fixed in a fiber base flange 16. The lens array 17 may be separated from the integrated positioning sheet 143 by a spacer 18 or an airspace 181 (both not shown). In other embodiments, the lens array 17 be directly laminated onto the integrated positioning sheet 143.

In assembly, one or more fibers or fiber bundles, after the coating of the optical fiber tips are stripped, may be threaded into the holes of the integrated positioning sheet 142, 143, (or, similarly through multilayer positioning sheet stack 141) through the fiber base flange 16 and/or the guide hole array block 15 (if present) and may remain protruding. The optical fiber and the holes may be bonded together and fixed by glue in the flat sheet stack 141, 142, 143. The optical fiber and the holes of the guide hole array block 15 may be fixed and sealed by high-reliability glue and/or sealant. The tail end of the optical fiber array may contain multiple optical fiber protective sleeves (not shown). After the different optical fiber bundles are assembled according to their positions, the tails may be sequentially collected in optical fiber protective sleeves; the multiple optical fiber protective sleeves may contain the optical fiber bundles fixed in the optical fiber protection sleeve. The fiber protection cover may be screwed to the back of the fiber base to complete the assembly of the fiber array. After the assembly is completed, the surface of the positioning flat sheet 11 (or integrated positioning sheet 142, 143), with the optical fibers protruding, may be ground and polished to complete the processing of the high-density two-dimensional optical fiber array. Finally, by the position tooling or the position substrate 40 (see also FIG. 7), the spacer 18 or air space 181, the lens array 17 and the fiber array may be bonded together to complete the assembly of the high-density two-dimensional fiber collimator array combination.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. An optical fiber array device, said optical fiber array device comprising:
a fiber base flange, enabled to hold an integrated positioning sheet;
said integrated positioning sheet comprising a plurality of channels, each of said channels formed by at least a positioning hole and a tapered hole;
a plurality of fibers or fiber bundles, each of said fibers or fiber bundles fixed in one of said positioning hole of said integrated positioning sheet; and
a lens array comprising a plurality of lenses, each lens of said lens array aligned with one channel of said plurality of channels.

2. The device according to claim 1, wherein said integrated positioning sheet is made from glass, silicon, monocrystalline silicon, or single crystal silicon.

3. The device according to claim 1, wherein said lens array is made from glass, silicon, monocrystalline silicon, or single crystal silicon.

4. The device according to claim 1, wherein said lens array is made from the same material as said integrated positioning sheet.

5. The device according to claim 1, wherein said fiber base flange is made from a material with a low thermal expansion coefficient.

6. The device according to claim 1, wherein each one of said plurality of channels comprises a hole located between said positioning hole and said tapered hole, such that said hole has a diameter that is larger than the diameter of the positioning hole and larger than the smallest diameter of said tapered hole.

7. The device according to claim 1, wherein said integrated positioning sheet comprises M×N channels arranged in an M×N array.

8. The device according to claim 1, wherein said positioning hole and/or said tapered hole are made using an etching process.

9. The device according to claim 1, wherein each of said fibers or fiber bundles is fixed in one of said positioning holes with glue.

10. The device according to claim 1, wherein said lens array is bonded directly onto said integrated positioning sheet.

11. The device according to claim 1, wherein the fiber base flange is enabled to hold said lens array.

12. The device according to claim 1, wherein the fiber base flange is enabled to hold a guide hole array block.

13. The device according to claim 1, comprising a spacer or an air space between said lens array and said integrated positioning sheet.

14. The device according to claim 1, wherein said fiber base flange and said lens array are fixed on a positioning substrate.

15. A method for assembling an optical fiber array device, said method comprising:
fixing an integrated positioning sheet in a fiber base flange;
forming a plurality of channels in said integrated positioning sheet, each of said channels comprising at least a positioning hole and a tapered hole;
fixing a plurality of fibers or fiber bundles in said integrated positioning sheet, each of said fibers or fiber bundles fixed in one of said positioning holes; and
aligning a lens array such that each lens of said lens array is aligned with one channel of said plurality of channels.

16. The method according to claim 15, making said integrated positioning sheet from glass, silicon, monocrystalline silicon, or single crystal silicon.

17. The method according to claim 15, making said lens array from glass, silicon, monocrystalline silicon, or single crystal silicon.

18. The method according to claim 15, making said lens array from the same material as said integrated positioning sheet.

19. The method according to claim 15, making said fiber base flange from a material with a low thermal expansion coefficient.

20. The method according to claim 15, making a hole between said positioning hole and said tapered hole, such that said hole has a diameter that is larger than the diameter of the positioning hole and larger than the smallest diameter of said tapered hole, for each one of said plurality of channels.

21. The method according to claim 15, arranging M×N channels on said integrated positioning sheet in an M×N array.

22. The method according to claim 15, using an etching process to make said positioning hole and/or said tapered hole.

23. The method according to claim 15, fixing each of said fibers or fiber bundles in one of said positioning holes with glue.

24. The method according to claim 15, bonding said lens array directly onto said integrated positioning sheet.

25. The method according to claim 15, enabling said the fiber base flange to hold said lens array.

26. The method according to claim 15, enabling the fiber base flange to hold a guide hole array block.

27. The method according to claim 15, spacing said lens array from said integrated positioning sheet using a spacer or an air space.

28. The method according to claim 15, fixing said fiber base flange and said lens array on a positioning substrate.
